(19) United States
(12) Patent Application Publication
(10) Pub. No.: US 2019/0110052 A1
(43) Pub. Date: Apr. 11, 2019

(54) BIDIRECTIONAL INTRA PREDICTION

(71) Applicant: Futurewei Technologies, Inc., Plano, TX (US)

(72) Inventors: Shan Liu, San Jose, CA (US); Jiali Fu, Shenzhen (CN)

(21) Appl. No.: 16/029,139

(22) Filed: Jul. 6, 2018

Related U.S. Application Data
(60) Provisional application No. 62/568,864, filed on Oct. 6, 2017.

(51) Int. Cl. H04N 19/159; H04N 19/182; H04N 19/176; H04N 19/124; H04N 19/577

(52) U.S. Cl. CPC H04N 19/159; H04N 19/182; H04N 19/577; H04N 19/124; H04N 19/176

(57) ABSTRACT

A method of coding implemented by a decoding device. The method includes determining, by the decoding device, a prediction direction for a current block; calculating, by the decoding device, an interpolated bottom right pixel; calculating, by the decoding device, interpolated bottom boundary pixels and interpolated right boundary pixels based on the interpolated bottom right pixel; predicting, by the decoding device, a pixel in the current block using a weighted average of two boundary pixels along the prediction direction, the two boundary pixels including at least one of the interpolated bottom boundary pixels or one of the interpolated right boundary pixels; and displaying, on a display of an electronic device, an image generated using the pixel that was predicted.

### CROSS-REFERENCE TO RELATED APPLICATIONS

This patent application claims the benefit of U.S. Provisional Patent Application No. 62/568,864, filed Oct. 6, 2017, by Shan Liu, et al., and titled “Bidirectional Intra Prediction,” the teaching and disclosure of which is hereby incorporated in its entirety by reference thereto.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video images. The compressed data is then received at the destination by a video decompression device that decodes the video data. With limited network resources and ever increasing demands of higher video quality, improved compression and decompression techniques that improve compression ratio with little to no sacrifice in image quality are desirable.

### SUMMARY

In an embodiment, the disclosure includes a method of coding implemented by a coding device. The method includes determining, by the decoding device, a prediction direction for a current block; calculating, by the decoding device, an interpolated bottom right pixel; calculating, by the decoding device, interpolated bottom boundary pixels and interpolated right boundary pixels based on the interpolated bottom right pixel; predicting, by the decoding device, a pixel in the current block using a weighted average of two boundary pixels along the prediction direction, the two boundary pixels including at least one of the interpolated bottom boundary pixels or one of the interpolated right boundary pixels; and displaying, on a display of an electronic device, an image generated using the pixel that was predicted.

Optionally, in any of the preceding aspects, another implementation of the aspect provides that the interpolated bottom right pixel is calculated according to:

i(n,n)=(w*r(−1,n)+h*r(n,−1)/(w+h)

where i(n,n) represents a size of the current block, where r(−1,n) represents a value of a left boundary pixel, where r(n,−1) represents a value of a top boundary pixel, and where w and h are distance-based weight values. Optionally, in any of the preceding aspects, another implementation of the aspect provides that the interpolated bottom boundary pixels and the interpolated right boundary pixels are calculated according to:

i(n,4)=(w*r(−1,n)+h*i(n,n)/(w+h)

i(4,n)=(w*r(n,−1)+h*i(n,n)/(w+h)

Optionally, in any of the preceding aspects, another implementation of the aspect provides that the pixel in the current block is predicted according to:

p(x,y)=(w*r_bottom+h*r_right/(w+h)

where r_bottom represents a value of one of the interpolated bottom boundary pixels, where r_right represents a value of one of the interpolated right boundary pixels, and where w and h are distance-based weight values. Optionally, in any of the preceding aspects, another implementation of the aspect provides predicting a second pixel in the current block according to:

p(x,y)=(w*r_left+h*r_above/(w+h)

where r_left represents a value of a left boundary pixel, where r_above represents a value of a top boundary pixel, and where w and h are distance-based weight values; and wherein the second pixel is above, left of, or above and left of the pixel in the current block. Optionally, in any of the preceding aspects, another implementation of the aspect provides that the two boundary pixels comprise a reconstructed boundary pixel and an interpolated bottom boundary pixel. Optionally, in any of the preceding aspects, another implementation of the aspect provides the two boundary pixels comprise a reconstructed boundary pixel and an interpolated right boundary pixel.

In an embodiment, the disclosure includes a method of coding implemented by a decoding device. The method includes determining, by the decoding device, a prediction direction for a current block; calculating, by the decoding device, an interpolated bottom right pixel; calculating, by the decoding device, interpolated bottom boundary pixels and interpolated right boundary pixels based on the interpolated bottom right pixel; predicting, by the decoding device, a pixel in the current block using a weighted average of two boundary pixels along the prediction direction, the two boundary pixels including at least one of the interpolated bottom boundary pixels or one of the interpolated right boundary pixels and at least one of a left boundary pixel or a top boundary pixel; and displaying, on a display of an electronic device, an image generated using the pixel that was predicted.

Optionally, in any of the preceding aspects, another implementation of the aspect provides that the interpolated bottom right pixel is calculated according to:

i(n,n)=(w*r(−1,n)+h*r(n,-1)/(w+h)

where i(n,n) represents a size of the current block, where r(−1,n) represents a value of a left boundary pixel, where r(n,−1) represents a value of a top boundary pixel, and where w and h are distance-based weight values.

Optionally, in any of the preceding aspects, another implementation of the aspect provides that the interpolated bottom boundary pixels and the interpolated right boundary pixels are calculated according to:

i(n,4)=(w*r(−1,n)+h*i(n,n)/(w+h)

i(4,n)=(w*r(n,-1)+h*i(n,n)/(w+h)

Optionally, in any of the preceding aspects, another implementation of the aspect provides that the pixel in the current block is predicted according to:

p(x,y)=(factor1*w1*i+factor1*h1*i+factor2*w2*r+factor2*h2*r)/(factor1*w1+factor1*h1+factor2*w2+factor2*h2)

where factor1 and factor2 each represent a pixel factor, where w1, w2, h1, and h2 are distance-based weight values, and where i represents a value of the one of the interpolated bottom boundary pixels or the one of the interpolated right boundary pixels.

Optionally, in any of the preceding aspects, another implementation of the aspect provides that the pixel factor for reconstructed pixels is higher than the pixel factor for interpolated boundary pixels. Optionally, in any of the preceding aspects, another implementation of the aspect provides that the left boundary pixel is a reconstructed pixel from a neighbor block immediately left of the current block and the top boundary pixel is a reconstructed pixel from a neighbor block immediately above the current block.

In an embodiment, the disclosure includes a decoding device including a memory storing instructions, a processor coupled to the memory, and a display coupled to the processor. The processor is configured to execute the instructions stored in the memory to cause the processor to determine a prediction direction for a current block, calculate an interpolated bottom right pixel, calculate interpolated bottom boundary pixels and interpolated right boundary pixels based on the interpolated bottom right pixel, compare a size of the current block to a size of a neighbor block, calculate interpolated neighbor boundary pixels for the neighbor block when the neighbor block is smaller than the current block, and predict a pixel in the current block using a weighted average of two boundary pixels along the prediction direction. The two boundary pixels include at least one of the interpolated neighbor boundary pixels from the neighbor block. The display configured to display an image generated using the pixel that was predicted.

Optionally, in any of the preceding aspects, another implementation of the aspect provides that the interpolated bottom right pixel is calculated according to:

i(n,n)=(w*r(−1,n)+h*r(n,−1)/(w+h)

where i(n,n) represents the size of the current block, where r(−1,n) represents a value of a left boundary pixel, where r(n,−1) represents a value of a top boundary pixel, and where w and h are distance-based weight values.

Optionally, in any of the preceding aspects, another implementation of the aspect provides that the interpolated bottom boundary pixels and the interpolated right boundary pixels are calculated according to:

i(n,4)=(w*r(−1,n)+h*i(n,n)/(w+h)

i(4,n)=(w*r(n,−1)+h*i(n,n)/(w+h)

Optionally, in any of the preceding aspects, another implementation of the aspect provides that the pixel in the current block is predicted according to:

p(x,y)=(w*r_bottom+h*r_right/(w+h)

where r_bottom represents a value of one of the interpolated bottom boundary pixels, where r_right represents a value of one of the interpolated right boundary pixels, and where w and h are distance-based weight values.

In an embodiment, the disclosure includes a method of coding implemented by a decoding device. The method includes determining, by the decoding device, a prediction direction for a current block; calculating, by the decoding device, an interpolated bottom right pixel; calculating, by the decoding device, interpolated bottom boundary pixels and interpolated right boundary pixels based on the interpolated bottom right pixel; predicting, by the decoding device, a pixel in the current block using a weighted average of two boundary pixels along the prediction direction, the two boundary pixels including only the interpolated bottom boundary pixels, the interpolated right boundary pixels, reconstructed reference pixels from a top neighbor block, or reconstructed reference pixels from a left neighbor block; and displaying, on a display of an electronic device, an image generated using the pixel that was predicted.

Optionally, in any of the preceding aspects, another implementation of the aspect provides that the interpolated bottom right pixel is calculated according to:

i(n,n)=(w*r(−1,n)+h*r(n,−1)/(w+h)

where i(n,n) represents a size of the current block, where r(−1,n) represents a value of a left boundary pixel, where r(n,−1) represents a value of a top boundary pixel, and where w and h are distance-based weight values, and wherein the interpolated bottom boundary pixels and the interpolated right boundary pixels are calculated according to:

i(n,4)=(w*r(−1,n)+h*i(n,n)/(w+h)

i(4,n)=(w*r(n,−1)+h*i(n,n)/(w+h)

Optionally, in any of the preceding aspects, another implementation of the aspect provides that the pixel in the current block is predicted according to:

p(x,y)=(w*r_bottom+h*r_right/(w+h)

where r_bottom represents a value of one of the interpolated bottom boundary pixels, where r_right represents a value of one of the interpolated right boundary pixels, and where w and h are distance-based weight values.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram illustrating an example coding system that may utilize bi-lateral prediction techniques.

FIG. 2 is a block diagram illustrating an example video encoder that may implement bi-lateral prediction techniques.

FIG. 3 is a block diagram illustrating an example of a video decoder that may implement bi-lateral prediction techniques.

FIG. 4 illustrates a mapping between the intra prediction mode number and the intra prediction direction.

FIG. 5 illustrates a current block to predict using reference pixels.

FIG. 6 illustrates a current block to predict using reference pixels.

FIG. 7 illustrates a current block to predict using reference pixels (interchangeably referred to herein as samples) and/or interpolated reference pixels.

FIGS. 8-9 illustrate a current block to predict using reference pixels and/or interpolated reference pixels.

FIG. 10 is an embodiment of a method of coding.

FIG. 11 is an embodiment of a method of coding.

FIG. 12 is an embodiment of a method of coding.

FIG. 13 is a schematic diagram of a network device (e.g., a coding device).

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

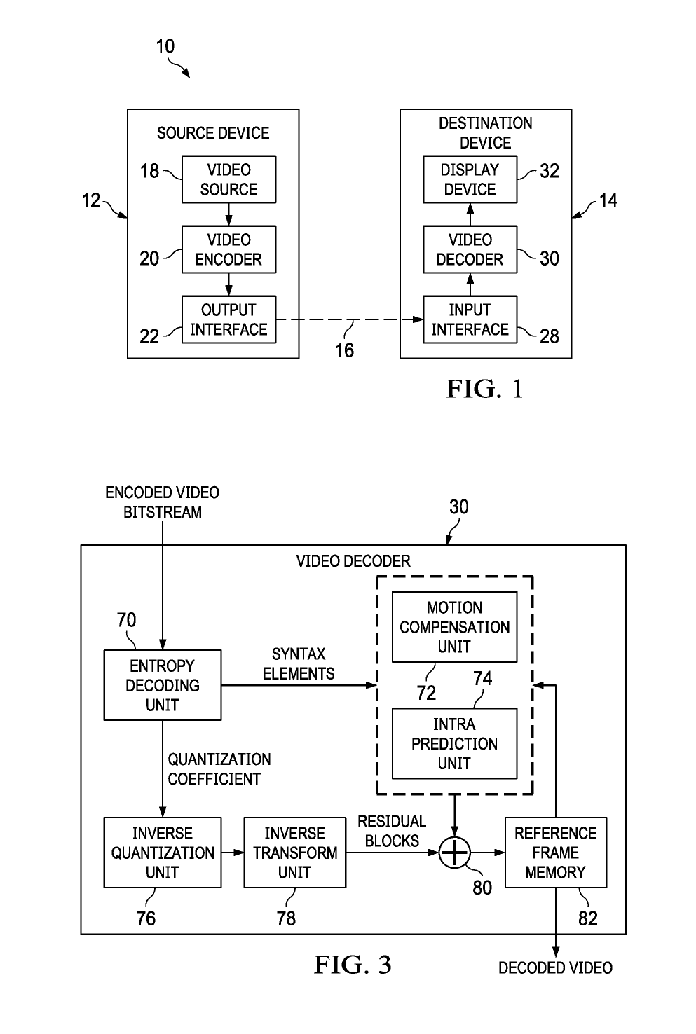

FIG. 1 is a block diagram illustrating an example coding system 10 that may utilize bidirectional prediction techniques. As shown in FIG. 1, the coding system 10 includes a source device 12 that provides encoded video data to be decoded at a later time by a destination device 14. In particular, the source device 12 may provide the video data to destination device 14 via a computer-readable medium 16. Source device 12 and destination device 14 may comprise any of a wide range of devices, including desktop computers, notebook (e.g., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, digital video disks (DVD)s, Compact Disc Read-Only Memories (CD-ROMs), flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), a file transfer protocol (FTP) server, network attached storage (NAS) devices, or a local disk drive. Destination device 14 may access the encoded video data through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, coding system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of the source device 12 and/or the video decoder 30 of the destination device 14 may be configured to apply the techniques for bidirectional prediction. In other examples, a source device and a destination device may include other components or arrangements. For example, source device 12 may receive video data from an external video source, such as an external camera. Likewise, destination device 14 may interface with an external display device, rather than including an integrated display device.

The illustrated coding system 10 of FIG. 1 is merely one example. Techniques for bidirectional prediction may be performed by any digital video encoding and/or decoding device. Although the techniques of this disclosure generally are performed by a video coding device, the techniques may also be performed by a video encoder/decoder, typically referred to as a “CODEC.” Moreover, the techniques of this disclosure may also be performed by a video preprocessor. The video encoder and/or the decoder may be a graphics processing unit (GPU) or a similar device.

Source device 12 and destination device 14 are merely examples of such coding devices in which source device 12 generates coded video data for transmission to destination device 14. In some examples, source device 12 and destination device 14 may operate in a substantially symmetrical manner such that each of the source and destination devices 12, 14 includes video encoding and decoding components. Hence, coding system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video.

In some cases, when video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., group of pictures (GOPs). Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 may operate according to a video coding standard, such as the High Efficiency Video Coding (HEVC) standard presently under development, and may conform to the HEVC Test Model (HM). Alternatively, video encoder 20 and video decoder 30 may operate according to other proprietary or industry standards, such as the International Telecommunications Union Telecommunication Standardization Sector (ITU-T) H.264 standard, alternatively referred to as Motion Picture Expert Group (MPEG)-4, Part 10, Advanced Video Coding (AVC), H.265/HEVC, or extensions of such standards. The techniques of this disclosure, however, are not limited to any particular coding standard. Other examples of video coding standards include MPEG-2 and ITU-T H.263. Although not shown in FIG. 1, in some aspects, video encoder 20 and video decoder 30 may each be integrated with an audio encoder and decoder, and may include appropriate multiplexer-demultiplexer (MUX-DEMUX) units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device. A device including video encoder 20 and/or video decoder 30 may comprise an integrated circuit, a microprocessor, and/or a wireless communication device, such as a cellular telephone.

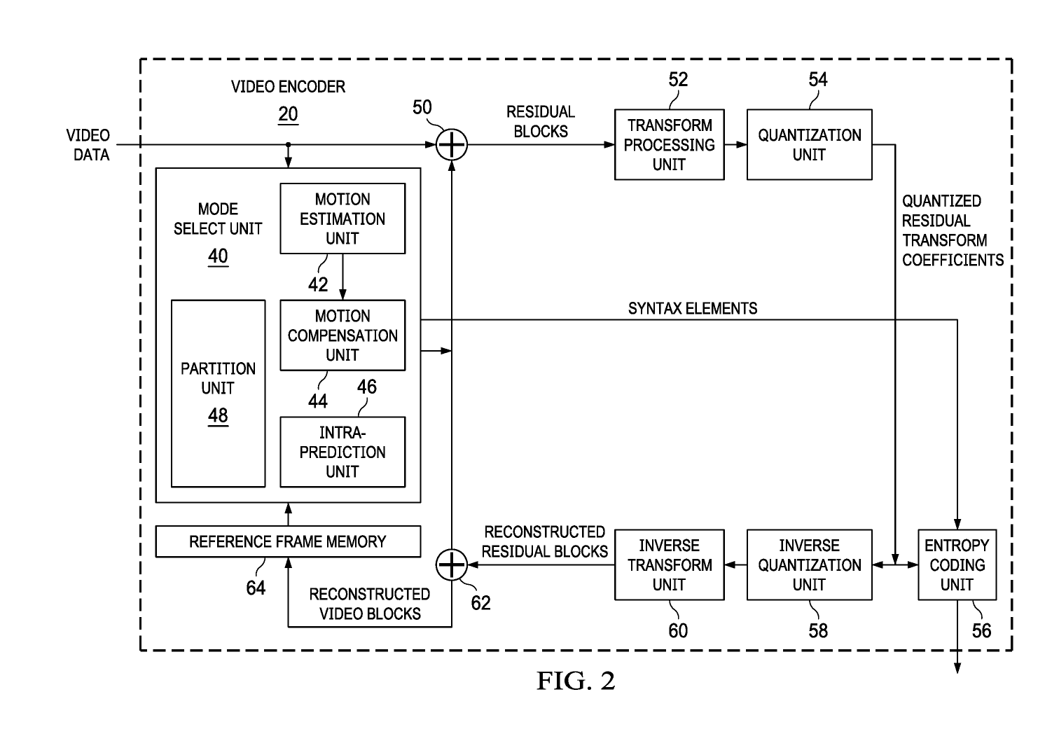

FIG. 2 is a block diagram illustrating an example of video encoder 20 that may implement bidirectional prediction techniques. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, reference frame memory 64, summer 50, transform processing unit 52, quantization unit 54, and entropy coding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into largest coding units (LCUs), and partition each of the LCUs into sub-coding units (sub-CUs) based on rate-distortion analysis (e.g., rate-distortion optimization). Mode select unit 40 may further produce a quad-tree data structure indicative of partitioning of a LCU into sub-CUs. Leaf-node CUs of the quad-tree may include one or more prediction units (PUs) and one or more transform units (TUs).

The present disclosure uses the term “block” to refer to any of a CU, PU, or TU, in the context of HEVC, or similar data structures in the context of other standards (e.g., macroblocks and sub-blocks thereof in H.264/AVC). A CU includes a coding node, PUs, and TUs associated with the coding node. A size of the CU corresponds to a size of the coding node and is square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quad-tree. A TU can be square or non-square (e.g., rectangular) in shape.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy coding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

In addition, intra-prediction unit 46 may be configured to code depth blocks of a depth map using a depth modeling mode (DMM). Mode select unit 40 may determine whether an available DMM mode produces better coding results than an intra-prediction mode and the other DMM modes, e.g., using rate-distortion optimization (RDO). Data for a texture image corresponding to a depth map may be stored in reference frame memory 64. Motion estimation unit 42 and motion compensation unit 44 may also be configured to inter-predict depth blocks of a depth map.

After selecting an intra-prediction mode for a block (e.g., a conventional intra-prediction mode or one of the DMM modes), intra-prediction unit 46 may provide information indicative of the selected intra-prediction mode for the block to entropy coding unit 56. Entropy coding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation.

Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used.

Transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy coding unit 56 entropy codes the quantized transform coefficients. For example, entropy coding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy coding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

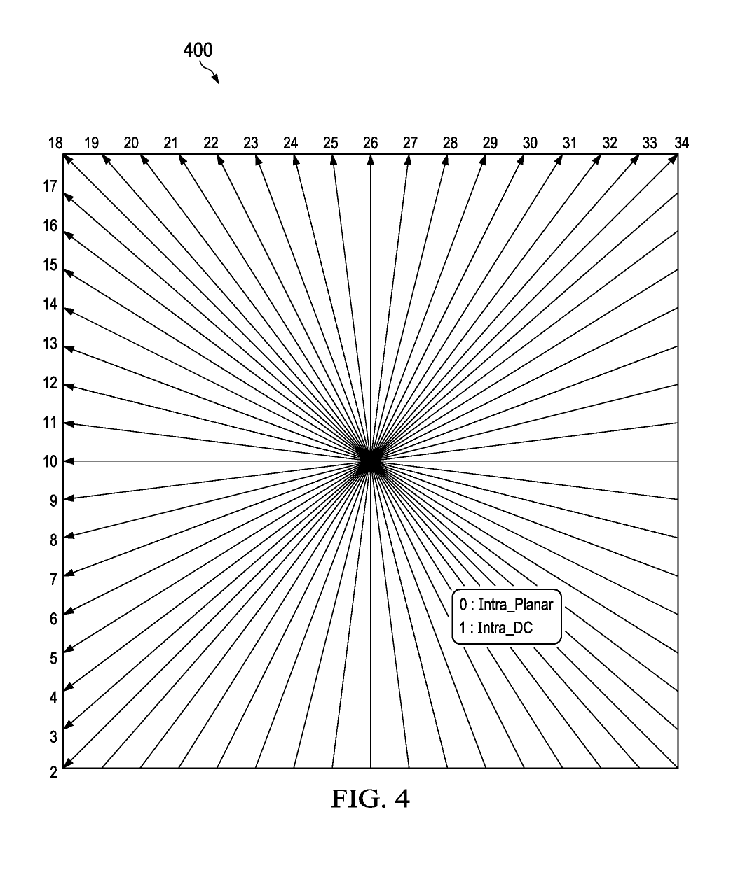

FIG. 3 is a block diagram illustrating an example of video decoder 30 that may implement bidirectional prediction techniques. In the example of FIG. 3, video decoder 30 includes an entropy decoding unit 70, motion compensation unit 72, intra-prediction unit 74, inverse quantization unit 76, inverse transformation unit 78, reference frame memory 82, and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of the video decoder 30 entropy decodes the bitstream to generate quantized coefficients, motion vectors or intra-prediction mode indicators, and other syntax elements. Entropy decoding unit 70 forwards the motion vectors and other syntax elements to motion compensation unit 72. Video decoder 30 may receive the syntax elements at the video slice level and/or the video block level.

When the video slice is coded as an intra-coded (I) slice, intra-prediction unit 74 may generate prediction data for a video block of the current video slice based on a signaled intra-prediction mode and data from previously decoded blocks of the current frame or picture. When the video frame is coded as an inter-coded (e.g., B, P, or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference frame memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Data for a texture image corresponding to a depth map may be stored in reference frame memory 82. Motion compensation unit 72 may also be configured to inter-predict depth blocks of a depth map.

Video compression techniques such as motion compensation, intra-prediction, and loop filters have been proved to be effective and thus adopted into various video coding standards, such as ITU-T H.264/AVC and ITU-T H.265/HEVC. As will be appreciated by those in the art, the coding system 10 of FIG. 1 is suitable for implementing these and other video compression techniques.

Intra prediction can be used when there is no available reference picture, or when inter-prediction coding is not used for the current block or picture. The reference samples of intra-prediction are usually derived from previously coded (or reconstructed) neighboring blocks in the same picture. For example, both in H.264/AVC and H.265/HEVC, the boundary samples of adjacent blocks are used as reference for intra-prediction. In particular, the decoded boundary samples of adjacent blocks are used as reference for spatial prediction in regions where inter-prediction is not performed.

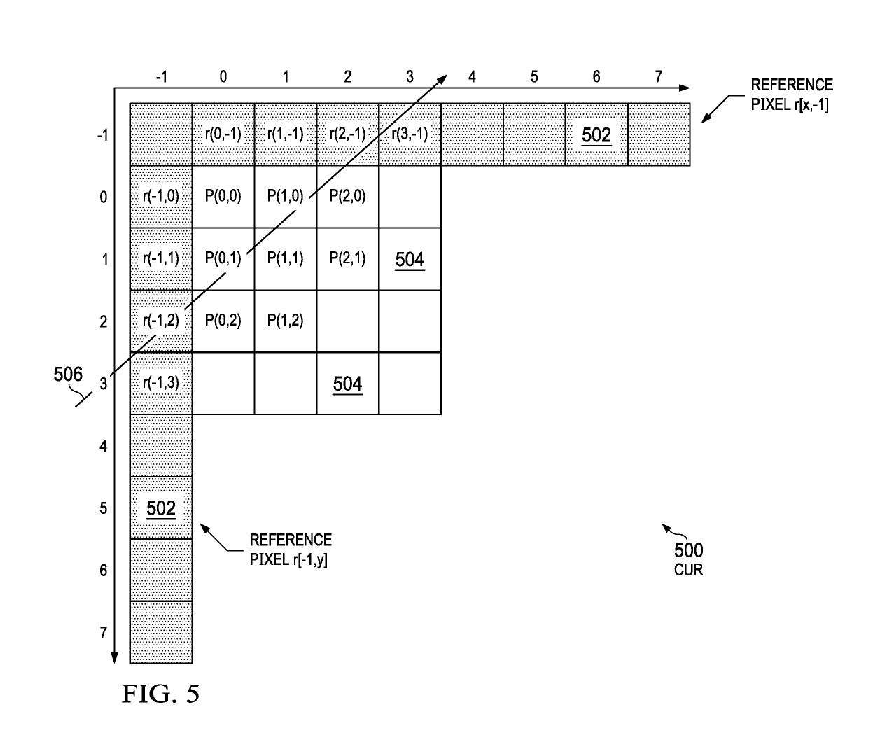

In order to cover different texture or structural character, there are many different intra-prediction modes. In each mode, a different prediction signal derivation method is used. For example, H.265/HEVC supports a total of 35 intra-prediction modes. FIG. 4 illustrates a mapping 400 between the intra-prediction mode number and the intra-prediction direction. The encoder selects the best luma intra-prediction mode of each block from 35 options: 33 directional prediction modes, a direct current (DC) mode, and a planar mode.

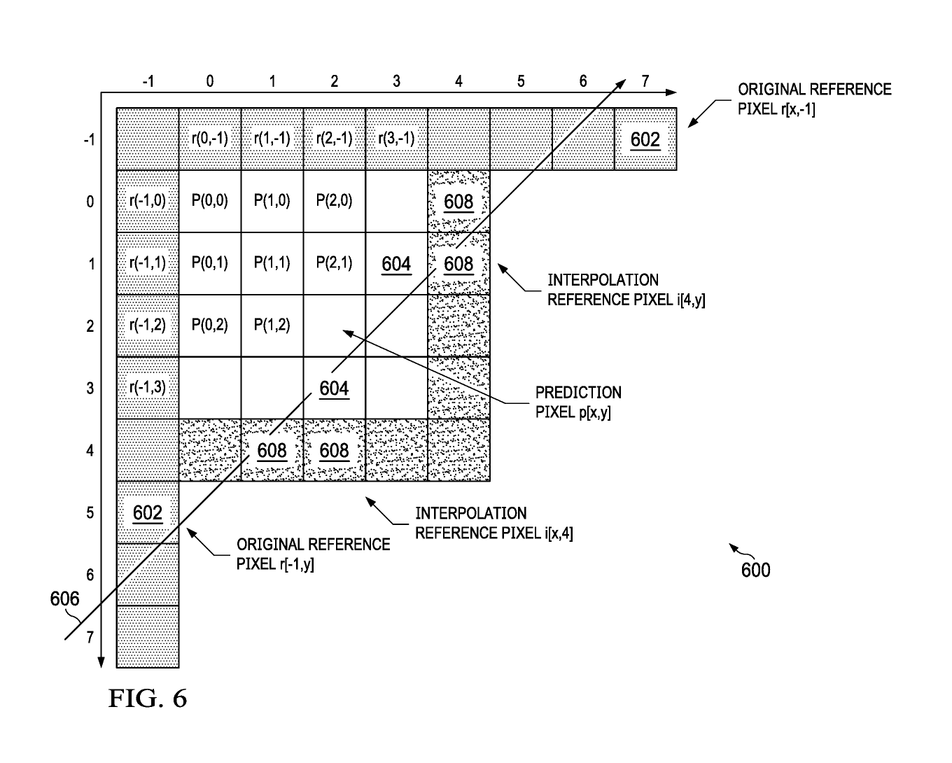

FIG. 5 illustrates a current block 500 to predict using reference pixels 502 (e.g., samples). In FIG. 5, the reference pixels 502 represent the row or column of pixels from the neighbor blocks (e.g., reconstructed blocks) immediately to the left or above the current block 500. Each reference pixel 502 may be identified using a coordinate system having an x-axis and a y-axis as shown in FIG. 5. For example, the references pixels 502 from the left neighbor block may be identified as r[−1,y] while the reference pixels 502 from a top neighbor row may be identified as r[x,−1].

A prediction signal can be derived by mapping the reference samples 502 according to a specific method indicated by one of the intra-prediction modes of FIG. 4. For example, the prediction value of a pixel 504 inside the current block 500 may be the same as the value of one of the left or above reference pixels 502 along the boundary of the current block 500 when a directional prediction mode is used.

Taking the 45 degree intra-mode (e.g., mode 2 in HEVC) as an example, which is depicted by arrow 506, the prediction value of a pixel 504 at location (x, y) in the current block 500, which is denoted p(x, y), can be derived as below:

p(0,0)=r(−1,1)

p(0,1)=p(1,0)=r(−1,2)

p(0,2)=p(1,1)=p(2,0)=r(−1,3)

p(0,3)=p(1,2)=p(2,1)=p(3,0)=r(−1,4)

p(1,3)=p(2,2)=p(3,1)=r(−1,5)

p(2,3)=p(3,2)=r(−1,6)

p(4,4)=r(−1,9)

That is, the value of the pixel 504 at position 0,0 gets the value of the reference pixel 502 at position −1,1, which is denoted r(−1,1). The value of the pixel 504 at position 0,1 and the value of the pixel 504 at position 1,0 get the value of the reference pixel 502 at position −1,2, which is denoted r(−1,2). The value of the pixel 504 at position 0,2, the value of the pixel 504 at position 1,1, and the value of the pixel 504 at position 2,0 each get the value of the reference pixel 502 at position −1, 3, which is denoted r(−1,3), and so on, according to the above formula.

In an alternative solution, the prediction value of a pixel 504 inside the current block 500 is calculated as the weighted average of the values of the left (or_bottom left) and above (or above right) reference pixels 502. Taking the 45 degree intra-mode as an example, the prediction value of a pixel at location (x, y) in the current block 500, which is denoted p(x, y), can be derived as below:

$$\begin{matrix}p ( 0 , 0 ) = ( w * r ( 1 , - 1 ) + h * r ( - 1 , 1 ) ) / ( w + h ) \\ p ( 0 , 1 ) = ( w * r ( 2 , - 1 ) + h * r ( - 1 , 2 ) ) / ( w + h ) \\ p ( 1 , 0 ) = ( w * r ( 2 , - 1 ) + h * r ( - 1 , 2 ) ) / ( w + h ) \\ … \\ p ( 2 , 2 ) = ( w * r ( 5 , - 1 ) + h * r ( - 1 , 5 ) ) / ( w + h ) \\ p ( 2 , 3 ) = ( w * r ( 6 , - 1 ) + h * r ( - 1 , 6 ) ) / ( w + h ) \\ p ( 3 , 2 ) = ( w * r ( 6 , - 1 ) + h * r ( - 1 , 6 ) ) / ( w + h ) \\ p ( 4 , 4 ) = ( w * r ( - 1 , 9 ) + h * r ( - 1 , 9 ) ) / ( w + h )\end{matrix}$$

where w and h represent distance-based weight values.

The above formulas are a general mathematical description. In an actual implementation, the division operation involves a factor in the rounding process, which is dependent on the denominator. However, the factor has been omitted herein for simplicity. The weight values of reference samples 502 are inversely proportional to the distance between the pixel being predicted and the position of the reference sample.

There are two potential problems with the prediction value generation for directional intra-prediction modes using weighted average. First, the directional intra-prediction mode uses only two location samples (e.g., top and left, top and bottom left, top right and left, top right and bottom left) as reference samples. Second, it only considers the distance-based weight value for the value of the prediction sample calculation.

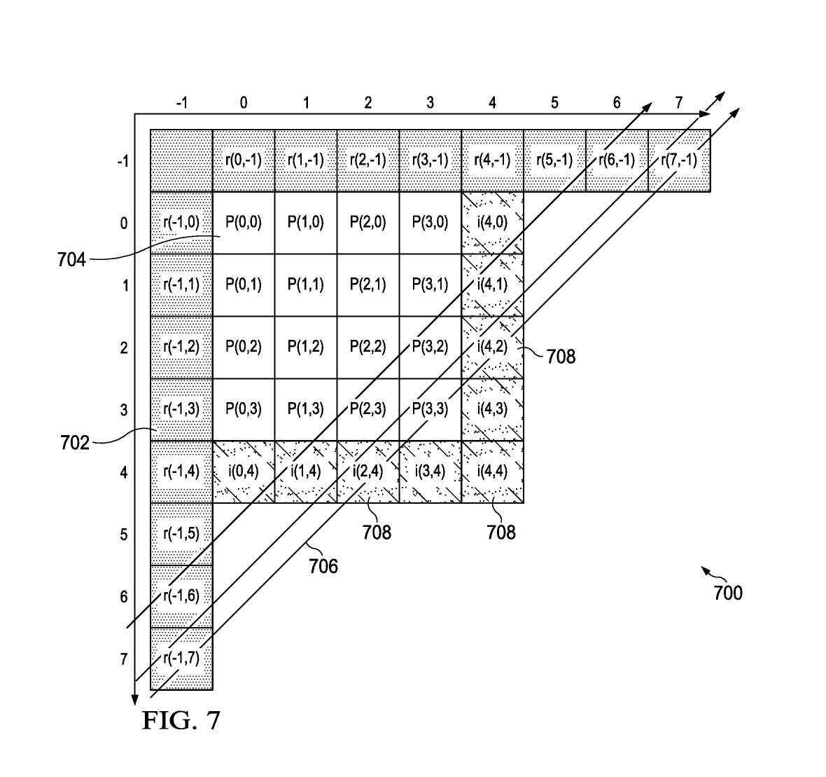

FIG. 6 illustrates a current block 600 of pixels 604 to predict using reference pixels 602 (e.g., samples) and/or interpolated reference pixels 608. Despite the compression advantage that has been shown for the intra-prediction in some circumstances, some areas can be improved to achieve higher coding gain. In particular, when the prediction angle line of the directional prediction mode (as shown by arrow 606) crosses the right and/or bottom boundary of the current block 600 as shown in FIG. 6, the intersect samples of the right boundary and/or the intersect samples of bottom boundary are considered to be the interpolated reference samples 608 for intra-prediction. In an embodiment, the reference samples from the right and/or bottom boundary could be either an original reference sample or the interpolated reference sample 608. The original reference samples are the samples from reconstructed samples of the neighboring block. The interpolated reference samples 608 are the samples from interpolation of original reference samples or duplication of original reference samples or a preset value.

Five methods have been identified to describe how to choose the reference samples and the weight. Each method is briefly summarized below.

1) The derivation method for the value of the prediction sample only uses the values of the reference pixels along the boundaries of the current block. That is, true reconstructed reference pixel values on above and left (e.g., pixels 502, 602 in FIGS. 5-6) and interpolated reference pixel values on right and bottom (e.g., pixels 608 in FIG. 6). The weight value of each reference sample is based on the distance between the reference samples and the prediction sample.

2) The derivation method for the value of the prediction sample uses all the available true reconstructed reference samples (e.g., above, above-right, left and/or bottom-left samples such as pixels 502, 602) and the interpolated reference samples (e.g., right and/or bottom samples such as pixels 608) if one or both of the true reconstructed reference samples along the intra-prediction direction is not available. The weight value of each reference sample is based on the distance between the reference samples and the prediction sample.

3) The derivation method for the value of the prediction sample uses all the available original reference samples (e.g., above, above-right, left and/or bottom-left) and the interpolated reference samples (e.g., right and/or bottom). The weight value of each reference sample is based on the distance between the reference samples and the prediction sample and a confidence factor. A higher confidence factor is used for the true reconstructed reference samples than the interpolated reference samples.

4) The derivation method for the value of the prediction sample uses all the original reference samples (e.g., above, above-right, left and/or bottom-left) and at least one interpolated reference sample (e.g., right and bottom), or using at least one of the original reference samples (e.g., up and left) and at least one interpolated reference sample (e.g., right and bottom). The weight value of each reference sample is based on the distance between the reference samples and the prediction sample and a confidence factor. A higher confidence factor is used for the true reconstructed reference samples than the interpolated reference samples.

5) If the left neighboring block size is bigger than the current coding block, then the bottom left neighboring reference samples are considered as the true reconstructed reference sample; if the left coding block size is smaller than current coding block, then the left neighboring reference sample is the original reference sample, the bottom left neighboring reference sample is the interpolated reference sample. The derivation method for the value of the prediction sample could be used with any of the aforementioned methods.

A set of embodiments are presented herein with emphasis on these methods.

At the encoder side, the encoder will encode the pixel according to these methods as shown in all embodiments. At the decoder side, the decoder will use these methods for decoding the bitstream to generate a list of decoded pictures.

### Embodiment 1

The derivation method of the value of the prediction sample using all the interpolation reference samples (e.g., right and bottom). The weight value of each reference sample is based on distance between the reference samples and the prediction sample.

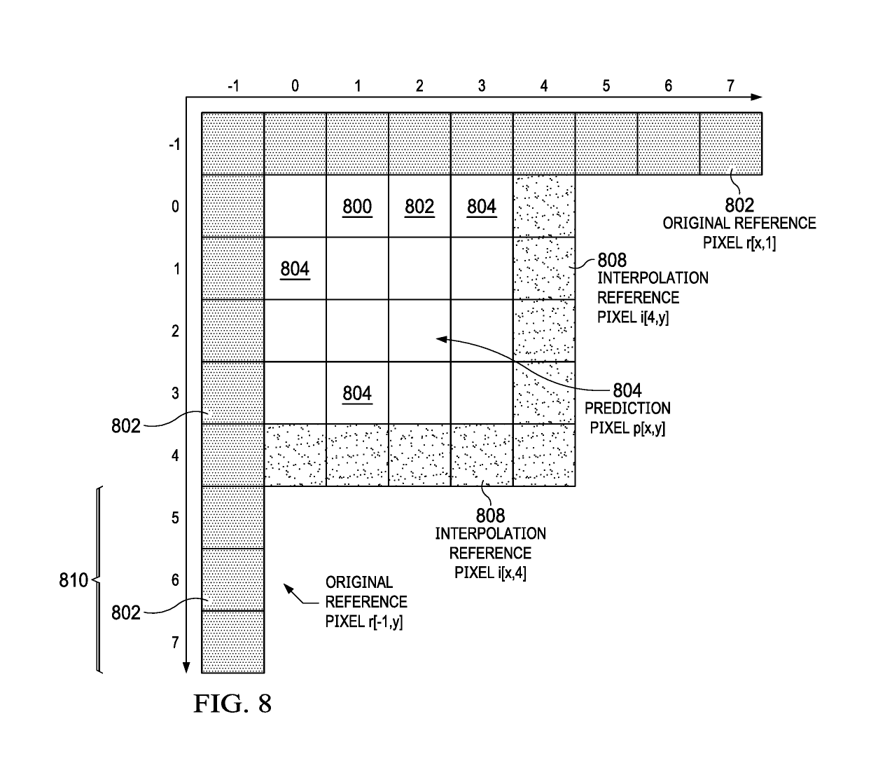

The notation used to define samples is shown in FIG. 7. FIG. 7 illustrates a current block 700 to predict using reference pixels 702 (interchangeably referred to herein as samples) and/or interpolated reference pixels 708. That is, a plurality of the prediction pixels 704 in the current block 700 will be predicted as described below. The prediction directional prediction mode is represented by arrow 706.

In FIG. 7, r[x,y] represents the original reference sample 702 at position (x,y), i[x,y] represents the interpolated reference sample 708 at position (x,y), and p[x, y] is the prediction sample at position (x,y). The designations x and y represent the horizontal and vertical distance from the block boundary.

Taking a 45-degree intra-mode as an example as shown in FIG. 7, the value of prediction sample p[x, y] is derived as follows:

Step 1: The value of the interpolated bottom right sample 708, which is i(4, 4) in FIG. 7, is derived as below:

i(4,4)=(w*r(−1,4)+h*r(4,-1))/(w+h)

where w is the distance-based weight value of left sample r(−1, 4) and h is the distance based weight value of top sample r(4, −1) For example: w=h=1. It should be appreciated that the interpolated bottom right sample 708 may be otherwise designated for a different sized current block 700. For example, for an 8×8 block the interpolated bottom right sample 708 would be designated i(8, 8).

Step 2: The values of interpolated reference samples 708 on the right and the bottom boundaries i(x, y) (x, y is integer) are derived as follows:

i(n,4)=(w*r(−1,4)+h*i(4,4))/(w+h)

where w is the distance-based weight value of right sample i(4, 4) and his the distance-based weight value of left sample r(−1, 4). For example: w=4-n, h=n−(−1). n=0˜3.

i(4,n)=(w*r(4,−1)+h*i(4,4))/(w+h)

where w is the distance-based weight value of top sample r(4,−1) and his the distance-based weight value of bottom sample i(4,4). For example: w=4-n, h=n−(−1). n=0˜3.

Step 3: The value of the prediction sample p[x][y](x, y are an integer) is derived as below:

1) The value of the prediction sample on the top and left region in the current block is derived as below:

p(x,y)=(w*r_left+h*r_above)/(w+h),x=0˜1,y=1-x

where w and h are the distance-based weight values. For example:

p(0,0)=(w*r(1,−1)+h*r(−1,1))/(w+h)w=h=1

P(0,1)=(w*r(2,−1)+h*r(−1,2))/(w+h)w=1,h=2

P(1,0)=(w*r(2,−1)+h*r(−1,2))/(w+h)w=2,h=1

p(1,1)=(w*r(3,−1)+h*r(−1,3))/(w+h)w=h=1

2) The values of the prediction samples on the right and bottom region in the current block is derived as below:

p(x,y)=(w*r_bottom+h*r_right)/(w+h)

where w and h are the distance-based weight values.

For example:

p(2,2)=(w*i(4,0)+h*i(0,4))/(w+h)w=1,h=1

p(3,1)=(w*i(4,0)+h*i(0,4))/(w+h)w=3,h=2

p(1,3)=(w*i(4,0)+h*i(0,4))/(w+h)w=2,h=3

p(3,2)=(w*i(4,1)+h*i(1,4))/(w+h)w=4,h=3

p(2,3)=(w*i(4,1)+h*i(1,4))/(w+h)w=3,h=4

p(3,3)=(w*i(4,2)+h*i(2,4))/(w+h)w=1,h=1

### Embodiment 2

The derivation method for the value of the prediction sample uses all the available original reference samples (e.g., up and/or left) and the interpolated reference samples (e.g., right and/or bottom), and it relates to the distance-based weight value as well as pixel factor. A higher pixel factor is used for the original reference samples 702 than the interpolated reference samples 708.

Taking 45-degree intra-mode as an example as shown in FIG. 7, the value of prediction sample p[x, y] is derived as following:

Step 1: The values of the interpolation right-bottom sample i(4, 4) are derived as below:

i(4,4)=(w*r(−1,4)+h*r(4,-1))/(w+h),

where w is the distance-based weight value of left sample r(−1, 4) and his the distance-based weight value of top sample r(4, −1). For example: w=h=1.

Step 2: The values of interpolation reference samples 708 on the right and the bottom boundaries i(x, y) (x, y is integer) are derived as below:

i(n,4)=(w*r(−1,4)+h*i(4,4))/(w+h)

where w is the distance-based weight value of right sample i(4, 4) and h is the distance-based weight value of left sample r(−1, 4). For example: w=4-n, h=n−(−1). n=0˜3.

i(4,n)=(w*r(4,−1)+h*i(4,4))/(w+h)

where w is the distance-based weight value of top sample r(4,−1) and h is the distance-based weight value of bottom sample i(4,4). For example: w=4-n, h=n−(−1). n=0˜3.

Step 3: The value of the prediction sample p[x][y](x, y is integer) is derived as below:

1) The value of the prediction sample on the top and left region in the current block is derived as below:

p(x,y)=(w*r_left+h*r_above)/(w+h),x=0˜3,y=3−x

where and h are the distance-based weight values.

For example:

p(0,0)=(w*r(1,−1)+h*r(−1,1))/(w+h)w=h=1

P(0,1)=(w*r(2,−1)+h*r(−1,2))/(w+h)w=1,h=2

P(1,0)=(w*r(2,−1)+h*r(−1,2))/(w+h)w=2,h=1

p(1,1)=(w*r(3,−1)+h*r(−1,3))/(w+h)w=h=1

2) The value of the prediction sample on the right and bottom region in the current block is derived as below:

p(x,x)=(factor1*w1*i+factor1*h1*i+factor2*w2*r+factor2*h2*r)/(factor1*w1+factor1*h1+factor2*w2+factor2*h2),x=2˜3

p(x,y)=(factor1*w1*i+factor1*h1*i+factor2*w2*r+factor2*h2*r)/(factor1*w1+factor1*h1+factor2*w2+factor2*h2),x=1˜3,y=3

p(x,y)=(factor1*w1*i+factor1*h1*i+factor2*w2*r+factor2*h2*r)/(factor1*w1+factor1*h1+factor2*w2+factor2*h2),x=3,y=1˜3

where w1, w2, h1, h2 are the distance-based weight value, factor1 and factor2 are the confidence factors, and high confidence factors are used for the true reconstructed reference samples (e.g., pixels 702) relative to the interpolated reference samples (e.g., pixels 708).

A preset value or default value could be used for pixel factor (e.g., fact1 and fact2) at the encoder and decoder side, or the value of pixel factor could be transmitted from encoder to decoder. Indeed, the encoder codes the value of pixel factor and the decoder parses it to get the value.

For example:

p(2,2)=(factor1*w1*i(4,0)+factor1*h1*i(0,4)+factor2*w2*r(5,-1)+factor2*h2*r(−1,5))/(factor1*w1+factor1*h1+factor2*w2+factor2*h2),w1=h1=1,w2=h2=1,factor1=1,factor2=3.

p(3,1)=(factor1*w1*i(4,0)+factor1*h1*i(0,4)+factor2*w2*r(5,-1)+factor2*h2*r(−1,5))/(factor1*w1+factor1*h1+factor2*w2+factor2*h2),w1=3,h1=2,w2=3,h2=2·factor1=1,factor2=3.

p(1,3)=(factor1*w1*i(4,0)+factor1*h1*i(0,4)+factor2*w2*r(5,-1)+factor2*h2*r(−1,5))/(factor1*w1+factor1*h1+factor2*w2+factor2*h2),w1=2,h1=3,w2=2,h2=3,factor1=1,factor2=3.

p(3,2)=(factor1*w1*i(4,1)+factor1*h1*i(1,4)+factor2*w2*r(6,−1)+factor2*h2*r(−1,6))/(factor1*w1+factor1*h1+factor2*w2+factor2*h2),w1=4,h1=3,w2=4,h2=3·factor1=1,factor2=3.

p(2,3)=(factor1*w1*i(4,1)+factor1*h1*i(1,4)+factor2*w2*r(6,-1)+factor2*h2*r(−1,6))/(factor1*w1+factor1*h1+factor2*w2+factor2*h2),w1=3,h1=4,w1=3,h1=4·factor1=1,factor2=3.

p(3,3)=(factor1*w1*i(7,-1)+factor1*h1*i(−1,7)+factor2*w2*r(7,−1)+factor2*h2*r(−1,7))/(factor1*w1+factor1*h1+factor2*w2+factor2*h2),w1=1,h1=1,w2=1,h2=1·factor1=1,factor2=3.

### Embodiment 3

The derivation method for the value of the prediction sample uses all the original reference samples (e.g., up and/or left) and at least one interpolated reference sample (e.g., right and bottom), or using at least one of the original reference samples (e.g., up and left) and at least one interpolated reference sample (e.g., right and bottom), and it relates to the distance-based weight value as well as pixel factor. A higher pixel factor is used for original reference samples (e.g., 702) relative to the interpolated reference samples (e.g., 708).

Taking 45-degree intra-mode as an example, the value of prediction sample p[x, y] is derived as following:

The step 1 and step 2 are the same as Embodiment 2 discussed above. The step 3 is changed as follows:

p(2,2)=(factor1*w1*i(4,0)+factor2*w2*r(5,−1)+factor2*h2*r(−1,5))/(factor1*w1+factor1*h1+factor2*h2),w1=1,w2=h2=1·factor1=1,factor2=3.

Or

p(2,2)=(factor1*h1*i(0,4)+factor2*w2*r(5,-1)+factor2*h2*r(−1,5))/(factor1*h1+factor2*w2+factor2*h2),h1=1,w2=h2=1·factor1=1,factor2=3.

In other embodiment, one of the interpolation samples 708 and one of reference samples 702 may be chosen to derive the prediction samples. For example, the step 1 and step 2 are the same as Embodiment 2, but the step 3 is changed as follows:

p(2,2)=(factor1*w1*i(4,0)+factor2*w2*r(5,−1))/(factor1*w1+factor2*w2),h1=1,w2=1·factor1=1,factor2=3.

Or

p(2,2)=(factor1*h1*i(0,4)+factor2*h2*r(−1,5))/(factor1*h1+factor2*h2),h1=1,w2=1·factor1=1,factor2=3.

### Embodiment 4

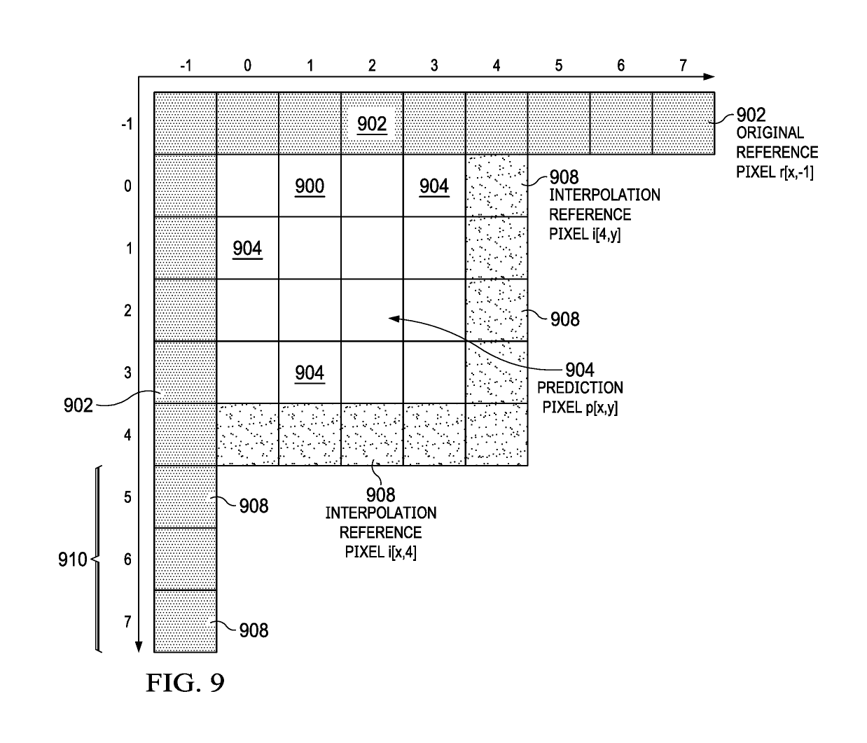

FIGS. 8-9 illustrate a current block 800, 900 to predict using reference pixels 802,902 (interchangeably referred to herein as samples) and/or interpolated reference pixels 808, 908. That is, a plurality of the prediction pixels 804, 904 in the current block 800, 900 will be predicted as described below.

If the neighbor block to the left of the current block 800 is larger in size (e.g., includes a larger number of pixels), then the bottom left neighboring reference samples 810 are considered to be original reference samples 802 as shown in FIG. 8. If, however, the neighbor block to the left of the current block 900 is smaller, then the bottom left neighboring reference samples 910 are the interpolated reference samples 908. The derivation method for the value of the prediction sample could be used for any of the aforementioned methods.

When generating the value of the prediction sample for directional intra-prediction mode, the value of top right reconstructed pixel and the value of the bottom left reconstructed pixel are used. In the existing solutions, the weights given to these two sample values only consider distance-based weight value, i.e., the weights are inversely proportional to the distance between the position of prediction sample and the position of bottom or right reference sample. That is, the further away the prediction sample, the smaller value is assigned, and vice versa.

In the present disclosure, besides a reconstructed sample, the right and bottom boundary samples will be interpolated as the interpolated reference sample, and different reference samples can be adaptively chosen to predict the current block samples. In addition, the weights of the reconstructed pixel (e.g., original reference sample) and the interpolated reference samples are different. That is, the original reference sample value is given a bigger factor than the interpolated reference samples for predicting the prediction sample. So, the present disclosure provides more accurate prediction values for samples in a current block.

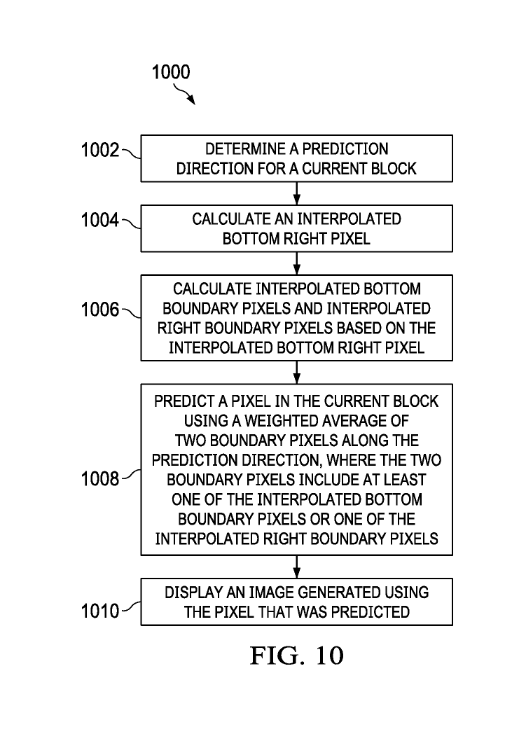

FIG. 10 is an embodiment of a method 1000 of coding. In an embodiment, the method 1000 is implemented by a decoding device (e.g., video decoder 30). In block 1002, a prediction direction is determined for a current block (e.g., current block 500-900 in FIGS. 5-9). The prediction direction may correspond to one of the prediction modes in FIG. 4 and/or the arrow 506, 606 in FIGS. 5-6. In block 1004, an interpolated bottom right pixel (or sample) is calculated. The interpolated bottom right pixel may be, for example, similar to the interpolated bottom right pixel 708 corresponding to i(4,4) in FIG. 7.

In block 1006, interpolated bottom boundary pixels and interpolated right boundary pixels are calculated based on the interpolated bottom right pixel. The interpolated bottom boundary pixels and interpolated right boundary pixels may be, for example, similar to the interpolated reference pixels 708 corresponding to i(0,4), i(1,4), i(2,4), i(3,4), i(4,0), i(4,1), i(4,2), and i(4,3) in FIG. 7.

In block 1008, a pixel in the current block is predicted using a weighted average of two boundary pixels along the prediction direction. In an embodiment, the two boundary pixels include at least one of the interpolated bottom boundary pixels or one of the interpolated right boundary pixels (e.g., one of the pixels 708 in the bottom boundary row or right boundary column). In block 1010, an image generated using the pixel that was predicted is displayed on the display of an electronic device.

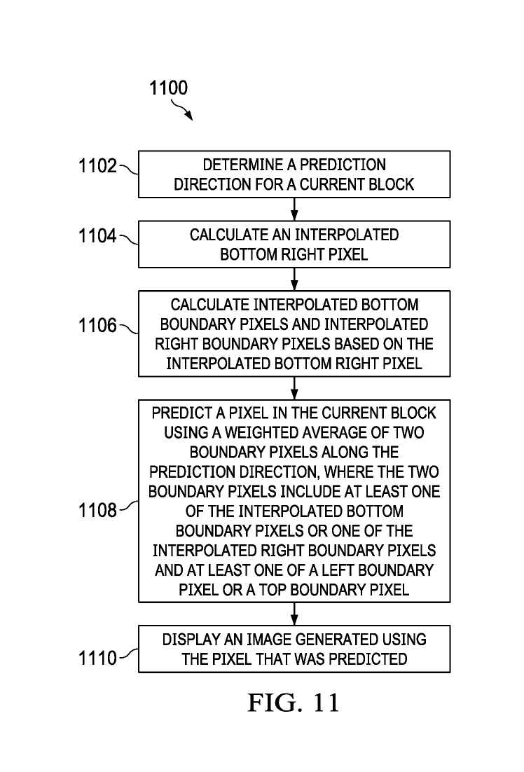

FIG. 11 is a method 1100 of coding. In an embodiment, the method 1100 is implemented by a decoding device (e.g., video decoder 30). In block 1102, a prediction direction is determined for a current block (e.g., current block 500-900 in FIGS. 5-9). The prediction direction may correspond to one of the prediction modes in FIG. 4 and/or the arrow 506, 606 in FIGS. 5-6. In block 1104, an interpolated bottom right pixel (or sample) is calculated. The interpolated bottom right pixel may be, for example, similar to the interpolated bottom right pixel 708 corresponding to i(4,4) in FIG. 7.

In block 1106, interpolated bottom boundary pixels and interpolated right boundary pixels are calculated based on the interpolated bottom right pixel. The interpolated bottom boundary pixels and interpolated right boundary pixels may be, for example, similar to the interpolated reference pixels 708 corresponding to i(0,4), i(1,4), i(2,4), i(3,4), i(4,0), i(4,1), i(4,2), and i(4,3) in FIG. 7.

In block 1108, a pixel in the current block is predicted using a weighted average of two boundary pixels along the prediction direction. In an embodiment, the two boundary pixels include at least one of the interpolated bottom boundary pixels or one of the interpolated right boundary pixels (e.g., one of the pixels 708 in the bottom boundary row or right boundary column) and at least one of the left boundary pixels or top boundary pixels (e.g., one of the pixels 702 in the top boundary row or left boundary column). In block 1110, an image generated using the pixel that was predicted is displayed on the display of an electronic device.

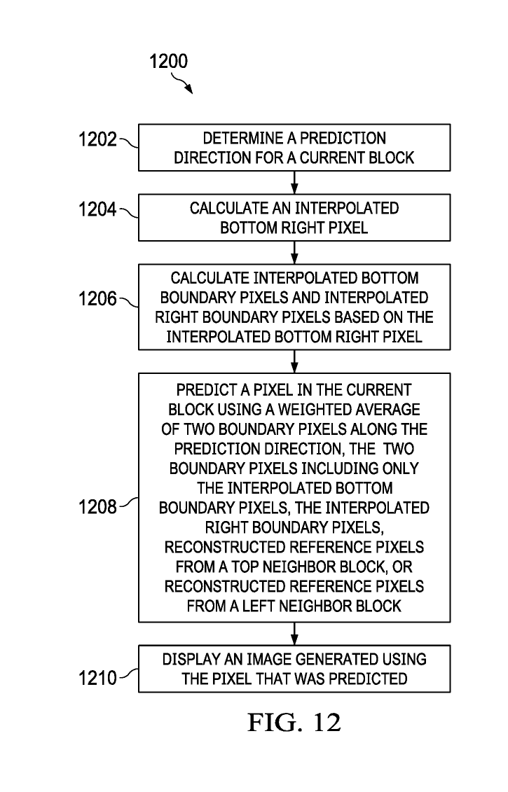

FIG. 12 is a method 1200 of coding. In an embodiment, the method 1200 is implemented by a decoding device (e.g., video decoder 30). In block 1202, a prediction direction is determined for a current block (e.g., current block 500-900 in FIGS. 5-9). The prediction direction may correspond to one of the prediction modes in FIG. 4 and/or the arrow 506, 606 in FIGS. 5-6. In block 1204, an interpolated bottom right pixel (or sample) is calculated. The interpolated bottom right pixel may be, for example, similar to the interpolated bottom right pixel 708 corresponding to i(4,4) in FIG. 7.

In block 1206, interpolated bottom boundary pixels and interpolated right boundary pixels are calculated based on the interpolated bottom right pixel. The interpolated bottom boundary pixels and interpolated right boundary pixels may be, for example, similar to the interpolated reference pixels 708 corresponding to i(0,4), i(1,4), i(2,4), i(3,4), i(4,0), i(4,1), i(4,2), and i(4,3) in FIG. 7.

In block 1208, a pixel in the current block is predicted using a weighted average of two boundary pixels along the prediction direction. In an embodiment, the two boundary pixels include only the interpolated bottom boundary pixels (e.g., pixels 708 from a bottom row), the interpolated right boundary pixels (e.g., pixels 708 from a right column), reconstructed reference pixels from a top neighbor block (e.g., pixels 702 from a top row), or reconstructed reference pixels from a left neighbor block (e.g., pixels 702 from a left column). In block 1210, an image generated using the pixel that was predicted is displayed on the display of an electronic device.

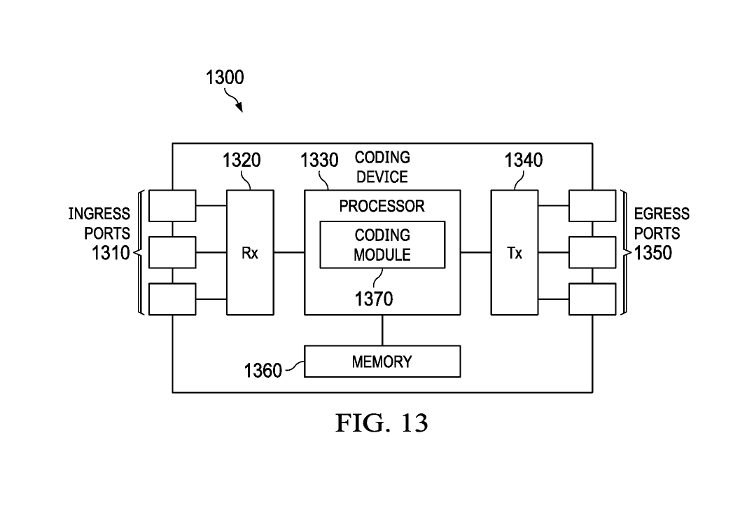

FIG. 13 is a schematic diagram of a coding device 1300 (e.g., a network device) according to an embodiment of the disclosure. The coding device 1300 is suitable for implementing the disclosed embodiments as described herein. The coding device 1300 comprises ingress ports 1310 and receiver units (Rx) 1320 for receiving data; a processor, logic unit, or central processing unit (CPU) 1330 to process the data; transmitter units (Tx) 1340 and egress ports 1350 for transmitting the data; and a memory 1360 for storing the data. The coding device 1300 may also comprise optical-to-electrical (OE) components and electrical-to-optical (EO) components coupled to the ingress ports 1310, the receiver units 1320, the transmitter units 1340, and the egress ports 1350 for egress or ingress of optical or electrical signals.

The processor 1330 is implemented by hardware and software. The processor 1330 may be implemented as one or more CPU chips, cores (e.g., as a multi-core processor), field-programmable gate arrays (FPGAs), application specific integrated circuits (ASICs), and digital signal processors (DSPs). The processor 1330 is in communication with the ingress ports 1310, receiver units 1320, transmitter units 1340, egress ports 1350, and memory 1360. The processor 1330 comprises a coding module 1370. The coding module 1370 implements the disclosed embodiments described above. For instance, the coding module 1370 implements the various coding operations disclosed herein. The inclusion of the coding module 1370 therefore provides a substantial improvement to the functionality of the coding device 1300 and effects a transformation of the coding device 1300 to a different state. Alternatively, the coding module 1370 is implemented as instructions stored in the memory 1360 and executed by the processor 1330.

The memory 1360 comprises one or more disks, tape drives, and solid-state drives and may be used as an over-flow data storage device, to store programs when such programs are selected for execution, and to store instructions and data that are read during program execution. The memory 1360 may be volatile and/or non-volatile and may be read-only memory (ROM), random access memory (RAM), ternary content-addressable memory (TCAM), and/or static random-access memory (SRAM).

In an embodiment, the disclosure includes a method of coding implemented by a coding means. The method includes determining, by the decoding means, a prediction direction for a current block; calculating, by the decoding means, an interpolated bottom right pixel; calculating, by the decoding means, interpolated bottom boundary pixels and interpolated right boundary pixels based on the interpolated bottom right pixel; predicting, by the decoding means, a pixel in the current block using a weighted average of two boundary pixels along the prediction direction, the two boundary pixels including at least one of the interpolated bottom boundary pixels or one of the interpolated right boundary pixels; and displaying, on a display means of an electronic means, an image generated using the pixel that was predicted.

In an embodiment, the disclosure includes a method of coding implemented by a decoding means. The method includes determining, by the decoding means, a prediction direction for a current block; calculating, by the decoding means, an interpolated bottom right pixel; calculating, by the decoding means, interpolated bottom boundary pixels and interpolated right boundary pixels based on the interpolated bottom right pixel; predicting, by the decoding means, a pixel in the current block using a weighted average of two boundary pixels along the prediction direction, the two boundary pixels including at least one of the interpolated bottom boundary pixels or one of the interpolated right boundary pixels and at least one of a left boundary pixel or a top boundary pixel; and displaying, on a display means of an electronic means, an image generated using the pixel that was predicted.

In an embodiment, the disclosure includes a decoding means including a memory means storing instructions, a processing means coupled to the memory means, and a display means coupled to the processing means. The processing means is configured to execute the instructions stored in the memory means to cause the processing means to determine a prediction direction for a current block, calculate an interpolated bottom right pixel, calculate interpolated bottom boundary pixels and interpolated right boundary pixels based on the interpolated bottom right pixel, compare a size of the current block to a size of a neighbor block, calculate interpolated neighbor boundary pixels for the neighbor block when the neighbor block is smaller than the current block, and predict a pixel in the current block using a weighted average of two boundary pixels along the prediction direction. The two boundary pixels include at least one of the interpolated neighbor boundary pixels from the neighbor block. The display means is configured to display an image generated using the pixel that was predicted.

In an embodiment, the disclosure includes a method of coding implemented by a decoding means. The method includes determining, by the decoding means, a prediction direction for a current block; calculating, by the decoding means, an interpolated bottom right pixel; calculating, by the decoding means, interpolated bottom boundary pixels and interpolated right boundary pixels based on the interpolated bottom right pixel; predicting, by the decoding means, a pixel in the current block using a weighted average of two boundary pixels along the prediction direction, the two boundary pixels including only the interpolated bottom boundary pixels, the interpolated right boundary pixels, reconstructed reference pixels from a top neighbor block, or reconstructed reference pixels from a left neighbor block; and displaying, on a display means of an electronic means, an image generated using the pixel that was predicted.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of coding implemented by a decoding device, comprising:
determining, by the decoding device, a prediction direction for a current block;
calculating, by the decoding device, an interpolated bottom right pixel;
calculating, by the decoding device, interpolated bottom boundary pixels and interpolated right boundary pixels based on the interpolated bottom right pixel;
predicting, by the decoding device, a pixel in the current block using a weighted average of two boundary pixels along the prediction direction, the two boundary pixels including at least one of the interpolated bottom boundary pixels or one of the interpolated right boundary pixels; and
displaying, on a display of an electronic device, an image generated using the pixel that was predicted.

2. The method of claim 1, wherein the interpolated bottom right pixel is calculated according to:
i(n,n)=(w*r(−1,n)+h*r(n,−1)/(w+h)
where i(n,n) represents a size of the current block, where r(−1,n) represents a value of a left boundary pixel, where r(n,−1) represents a value of a top boundary pixel, and where w and h are distance-based weight values.

3. The method of claim 2, wherein the interpolated bottom boundary pixels and the interpolated right boundary pixels are calculated according to:
i(n,4)=(w*r(−1,n)+h*i(n,n)/(w+h)
i(4,n)=(w*r(n,−1)+h*i(n,n)/(w+h)

4. The method of claim 1, wherein the pixel in the current block is predicted according to:
p(x,y)=(w*r_bottom+h*r_right/(w+h)
where r_bottom represents a value of one of the interpolated bottom boundary pixels, where r_right represents a value of one of the interpolated right boundary pixels, and where w and h are distance-based weight values.

5. The method of claim 1, further comprising predicting a second pixel in the current block according to:
p(x,y)=(w*r_left+h*r_above/(w+h)
where r_left represents a value of a left boundary pixel, where r_above represents a value of a top boundary pixel, and where w and h are distance-based weight values; and wherein the second pixel is above, left of, or above and left of the pixel in the current block.

6. The method of claim 1, wherein the two boundary pixels comprise a reconstructed boundary pixel and an interpolated bottom boundary pixel.

7. The method of claim 1, wherein the two boundary pixels comprise a reconstructed boundary pixel and an interpolated right boundary pixel.

8. A method of coding implemented by a decoding device, comprising:
determining, by the decoding device, a prediction direction for a current block;
calculating, by the decoding device, an interpolated bottom right pixel;
calculating, by the decoding device, interpolated bottom boundary pixels and interpolated right boundary pixels based on the interpolated bottom right pixel;
predicting, by the decoding device, a pixel in the current block using a weighted average of two boundary pixels along the prediction direction, the two boundary pixels including at least one of the interpolated bottom boundary pixels or one of the interpolated right boundary pixels and at least one of a left boundary pixel or a top boundary pixel; and
displaying, on a display of an electronic device, an image generated using the pixel that was predicted.

9. The method of claim 8, wherein the interpolated bottom right pixel is calculated according to:
i(n,n)=(w*r(−1,n)+h*r(n,−1)/(w+h)
where i(n,n) represents a size of the current block, where r(−1,n) represents a value of a left boundary pixel, where r(n,−1) represents a value of a top boundary pixel, and where w and h are distance-based weight values.

10. The method of claim 8, wherein the interpolated bottom boundary pixels and the interpolated right boundary pixels are calculated according to:
i(n,4)=(w*r(−1,n)+h*i(n,n)/(w+h)
i(4,n)=(w*r(n,-1)+h*i(n,n)/(w+h)

11. The method of claim 8, wherein the pixel in the current block is predicted according to:
p(x,y)=(factor1*w1*i+factor1*h1*i+factor2*w2*r+factor2*h2*r)/(factor1*w1+factor1*h1+factor2*w2+factor2*h2)
where factor1 and factor2 each represent a pixel factor, where w1, w2, h1, and h2 are distance-based weight values, and where i represents a value of the one of the interpolated bottom boundary pixels or the one of the interpolated right boundary pixels.

12. The method of claim 11, wherein the pixel factor for reconstructed pixels is higher than the pixel factor for interpolated boundary pixels.

13. The method of claim 8, wherein the left boundary pixel is a reconstructed pixel from a neighbor block immediately left of the current block and the top boundary pixel is a reconstructed pixel from a neighbor block immediately above the current block.

14. A decoding device, comprising:
a memory storing instructions; and
a processor coupled to the memory, the processor configured to execute the instructions stored in the memory to cause the processor to:
determine a prediction direction for a current block;
calculate an interpolated bottom right pixel;
calculate interpolated bottom boundary pixels and interpolated right boundary pixels based on the interpolated bottom right pixel;
compare a size of the current block to a size of a neighbor block;
calculate interpolated neighbor boundary pixels for the neighbor block when the neighbor block is smaller than the current block; and
predict a pixel in the current block using a weighted average of two boundary pixels along the prediction direction, the two boundary pixels including at least one of the interpolated neighbor boundary pixels from the neighbor block; and
a display coupled to the processor, the display configured to display an image generated using the pixel that was predicted.

15. The decoding device claim 14, wherein the interpolated bottom right pixel is calculated according to:
i(n,n)=(w*r(−1,n)+h*r(n,−1)/(w+h)
where i(n,n) represents the size of the current block, where r(−1,n) represents a value of a left boundary pixel, where r(n,−1) represents a value of a top boundary pixel, and where w and h are distance-based weight values.

16. The decoding device claim 15, wherein the interpolated bottom boundary pixels and the interpolated right boundary pixels are calculated according to:
i(n,4)=(w*r(−1,n)+h*i(n,n)/(w+h)
i(4,n)=(w*r(n,−1)+h*i(n,n)/(w+h)

17. The decoding device claim 15, wherein the pixel in the current block is predicted according to:
p(x,y)=(w*r_bottom+h*r_right/(w+h)
where r_bottom represents a value of one of the interpolated bottom boundary pixels, where r_right represents a value of one of the interpolated right boundary pixels, and where w and h are distance-based weight values.

18. A method of coding implemented by a decoding device, comprising:
determining, by the decoding device, a prediction direction for a current block;
calculating, by the decoding device, an interpolated bottom right pixel;
calculating, by the decoding device, interpolated bottom boundary pixels and interpolated right boundary pixels based on the interpolated bottom right pixel;
predicting, by the decoding device, a pixel in the current block using a weighted average of two boundary pixels along the prediction direction, the two boundary pixels including only the interpolated bottom boundary pixels, the interpolated right boundary pixels, reconstructed reference pixels from a top neighbor block, or reconstructed reference pixels from a left neighbor block; and
displaying, on a display of an electronic device, an image generated using the pixel that was predicted.

19. The method of claim 1, wherein the interpolated bottom right pixel is calculated according to:
i(n,n)=(w*r(−1,n)+h*r(n,−1)/(w+h)
where i(n,n) represents a size of the current block, where r(−1,n) represents a value of a left boundary pixel, where r(n,−1) represents a value of a top boundary pixel, and where w and h are distance-based weight values, and wherein the interpolated bottom boundary pixels and the interpolated right boundary pixels are calculated according to:
i(n,4)=(w*r(−1,n)+h*i(n,n)/(w+h)
i(4,n)=(w*r(n,−1)+h*i(n,n)/(w+h)

20. The method of claim 1, wherein the pixel in the current block is predicted according to:
p(x,y)=(w*r_bottom+h*r_right/(w+h)
where r_bottom represents a value of one of the interpolated bottom boundary pixels, where r_right represents a value of one of the interpolated right boundary pixels, and where w and h are distance-based weight values.
